(19) United States
(12) Patent Application Publication
(10) Pub. No.: US 2025/0252115 A1
(43) Pub. Date: Aug. 7, 2025

(54) FUNCTION SEQUENCING TO STRUCTURE UNSTRUCTURED INFORMATION

(71) Applicant: CVS PHARMACY, INC.

(72) Inventors: Lisa Nicastro, Cheshire, CT (US); Maksim Chepel, Brussel, NY (US); Michael Denatale, Cheshire, CT (US)

(21) Appl. No.: 18/431,665

(22) Filed: Feb. 2, 2024

(51) Int. Cl. G06F 16/25; G06F 9/50; G06V 30/413

(52) U.S. Cl. CPC G06F 16/258; G06F 9/5038; G06V 30/413

(57) ABSTRACT

A system can include one or more memory devices storing instructions thereon, that, when executed by one or more processors, cause the one or more processors to receive a request to identify information of a document stored in a file, the request comprising an identifier. The instructions cause the one or more processors to select a configuration file from a plurality of configuration files using the identifier. The instructions cause the one or more processors to execute a sequence of functions defined by the configuration file to identify the information in the file. The instructions cause the one or more processors to generate a result file including the information identified by execution of the sequence of functions.

### BACKGROUND

A computing system can identify data in an unstructured data file. For example, the computing system can perform character recognition in a document.

### SUMMARY

At least one aspect of the present disclosure is directed to a system. The system can include one or more memory devices storing instructions thereon, that, when executed by one or more processors, cause the one or more processors to receive a request to identify information of a document stored in a file, the request comprising an identifier. The instructions can cause the one or more processors to select a configuration file from a plurality of configuration files using the identifier. The instructions can cause the one or more processors to execute a sequence of functions defined by the configuration file to identify the information in the file. The instructions can cause the one or more processors to generate a result file including the information identified by execution of the sequence of functions.

In some implementations, the file includes at least one image of the document. In some implementations, the information of the document is represented as unlabeled pixel data in the image.

In some implementations, the configuration file identifies functions of the sequence of functions and an order to execute the functions to process the file of the document. In some implementations, a second configuration file of configuration files identifies functions of the sequence of functions and an order to execute the functions to process the file.

The instructions can cause the one or more processors to allocate first memory or processing resources to a first function of the sequence of functions. The instructions can cause the one or more processors to execute the first function to process the file of the document with the first memory or processing resources. The instructions can cause the one or more processors to release the first memory or processing resources responsive to the first function completing processing the file. The instructions can cause the one or more processors to allocate second memory or processing resources to a second function of the sequence of functions responsive to a completion of the first function. The instructions can cause the one or more processors to execute the second function to process the file with the second memory or processing resources.

In some implementations, the sequence of functions defined by the configuration file includes a first function to execute on the file followed by a second function to execute on the file. In some implementations, the instructions can cause the one or more processors to store a plurality of functions on the one or more memory devices. The instructions can cause the one or more processors to transmit a request to the first function to execute on the file. The instructions can cause the one or more processors to transmit a request to the second function to execute on the file responsive to the first function executing on the file.

The instructions can cause the one or more processors to execute a function of the sequence of functions defined by the configuration file to split the document into a plurality of portions. The instructions can cause the one or more processors to store a plurality of unstructured data elements for the plurality of portions of the document. The instructions can cause the one or more processors to execute at least one function of the sequence of functions defined by the configuration file on the plurality of unstructured data elements.

The instructions can cause the one or more processors to generate an identification of a portion of the document. The instructions can cause the one or more processors to determine that a confidence of the identification is less than a threshold. The instructions can cause the one or more processors to generate a message to include an indication of the identification and the portion of the document. The instructions can cause the one or more processors to push the message to a front-end server to cause the front-end server to display the identification and the portion of the document on a digital display.

The instructions can cause the one or more processors to transmit, using a webhook, a message to a front-end server to cause the front-end server to display data responsive to a determination that a confidence of an identification of a portion of the document is less than a threshold. The data can include an indication of the identification of the portion of the document and an indication of the portion of the document.

The instructions can cause the one or more processors to receive a plurality of messages comprising identifications of different portions of the document. The instructions can cause the one or more processors to generate data to cause a digital display to display the identifications of the different portions of the document within a single framework, without using different types for frameworks, for different types of documents or portions of documents.

In some implementations, the sequence of functions defined by the configuration file includes a first function to execute on the file followed by a second function to execute on the file. In some implementations, the instructions cause the one or more processors to transmit a request to the first function to execute on the file to identify an identification of a portion of the document. The instructions can cause the one or more processors to transmit a request to the second function to compare the identification of the portion of the document with data of a database to generate an alert. The instructions can cause the one or more processors to generate data to cause a digital display to display the alert.

In some implementations, the instructions cause the one or more processors to generate data to cause a digital display to display a list of a plurality of documents comprising identification errors, the plurality of documents comprising the document. The instructions can cause the one or more processors to receive a selection of the document from the plurality of documents. The instructions can cause the one or more processors to transmit a request to a back-end server to request a data structure from storage, the data structure representing a field of the document with an error flag. The instructions can cause the one or more processors to generate data to cause the digital display to display an indication of the field of the document using the data structure.

In some implementations, the instructions cause the one or more processors to generate data to cause a digital display to display an indication of a field of the document with an identification error. The instructions can cause the one or more processors to receive user input via the digital display comprising an identification of the field. The instructions can cause the one or more processors to transmit an update to the field to a back-end server responsive to receiving the identification of the field to cause the back-end server to store the identification received via the digital display.

In some implementations, the instructions cause the one or more processors to generate a plurality of events that indicate identification errors of a plurality of different portions of the document. The instructions can cause the one or more processors to publish the plurality of events to an event topic, wherein an agent is subscribed to the event topic. The instructions can cause the one or more processors to execute the agent to collect the plurality of events published to the event topic and forward to events to a server to be delivered to a front-end server via at least one webhook.

At least one aspect of the present disclosure is directed to a method. The method can include receiving, by one or more processing circuits, a request to identify information of a document stored in a file, the request comprising an identifier. The method can include selecting, by the one or more processing circuits, a configuration file from a plurality of configuration files using the identifier. The method can include executing, by the one or more processing circuits, a sequence of functions defined by the configuration file to identify the information in the file. The method can include generating, by the one or more processing circuits, a result file including the information identified by execution of the sequence of functions.

In some implementations, the configuration file identifies functions of the sequence of functions and an order to execute the functions to process the file. In some implementations, a second configuration file of configuration files identifies functions of the sequence of functions and an order to execute the functions to process the file.

In some implementations, the method can include executing, by the one or more processing circuits, a function of the sequence of functions defined by the configuration file to split the document into a plurality of portions. In some implementations, the method can include storing, by the one or more processing circuits, a plurality of unstructured data elements for the plurality of portions of the document. In some implementations, the method can include executing, by the one or more processing circuits, at least one function of the sequence of functions defined by the configuration file on the plurality of unstructured data elements.

In some implementations, the method can include generating, by the one or more processing circuits, an identification of a portion of the document. The method can include determining, by the one or more processing circuits, that a confidence of the identification is less than a threshold. The method can include generating, by the one or more processing circuits, a message to include an indication of the identification and the portion of the document. The method can include pushing, by the one or more processing circuits, the message to a front-end server to cause the front-end server to display the identification and the portion of the document on a digital display.

The method can include receiving, by the one or more processing circuits, a plurality of messages comprising identifications of different portions of the document. The method can include generating, by the one or more processing circuits, data to cause a digital display to display the identifications of the different portions of the document within a single framework, without using different types for frameworks, for different types of documents or portions of documents.

At least one aspect of the present disclosure is directed to one or more storage media storing instructions thereon that, when executed by one or more processors, cause the one or more processors perform operations including receiving a request to identify information of a document stored in a file, the request comprising an identifier. The operations can include selecting a configuration file from a plurality of configuration files using the identifier. The operations can include executing a sequence of functions defined by the configuration file to identify the information in the file. The operations can include generating a result file including the information identified by execution of the sequence of functions.

In some implementations, the configuration file identifies functions of the sequence of functions and an order to execute the functions to process the file. In some implementations, a second configuration file of plurality of configuration files identifies functions of the sequence of functions and an order to execute the functions to process the file.

In some implementations, the operations include receiving a plurality of messages comprising identifications of different portions of the document. In some implementations, the operations include generating data to cause a digital display to display the identifications of the different portions of the document within a single framework, without using different types for frameworks, for different types of documents or portions of documents.

All examples and features mentioned above can be combined in any technically possible way.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 is an example system for function sequencing to process unstructured information.

FIG. 2 is an example computing system for dynamically allocating resources to functions to process unstructured information.

FIG. 3 is an example method of function sequencing to process unstructured information.

FIG. 4 is an example computing architecture of a computing system.

### DETAILED DESCRIPTION

Following below are more detailed descriptions of various concepts related to, and implementations of, methods, apparatuses, and systems of function sequencing for unstructured information. The various concepts introduced above and discussed in greater detail below may be implemented in any of numerous ways.

A computing system can receive files of documents, such as scanned files, scanned images, images captured by cameras, etc. The computing system can perform operations such as character recognition, language processing, storage functions, etc. to identify fields or information within the file. Furthermore, the computing system can compare information of the fields with information stored in a database, e.g., to verify that an amount of a check matches an expected amount. However, the computing system can consume a large amount of computing resources (e.g., processing resources, memory resources, power consumption) because the operations that the computing system utilizes may all have their own computing resource allocation. For example, when the computing system loads instructions or software into memory to process the file, all of the operations such as character recognition, language processing, etc. may be loaded into memory or allocated processing resources, even though not all of the operations need to be executed at the same time. Furthermore, many of the operations that the computing system executes can be resource intensive, e.g., they may include large models trained by machine learning, and therefore, the length of time to process the file can be large when computing resources are utilized in this way.

Furthermore, the computing system can have a hardcoded order in which to execute the various operations, e.g., split a set of images of a document into multiple files, one for each page of the document, process each file with character recognition, process each file with language recognition, etc. Each time a new use case arises, where a new type of document may need to be processed, a new type of field of a document needs to be processed, etc. a programmer, designer, or engineer may need to re-design the software executed by the computing system to handle a new order of steps to be executed.

Furthermore, when the computing system identifies a field with a confidence level less than a threshold, a user may need to manually review the field. The computing system can include a digital display to display an image of the field along with an identification of the field determined by the computing system. However, the digital display may need to be re-developed or re-configured each time a new type of document or new type of field needs to be displayed in the digital display and adjudicated by a user.

To solve for these, and other technical issues, this technical solution can include a computing system that sequences functions to process unstructured information. The computing system can combine configurable import processes, processes to extract unstructured data into structured data through artificial intelligence models or machine learning models, a front-end for an analyst or user, and a configurable export process. The computing system can store multiple configuration files, each configuration file defining the order in which to execute functions. Each configuration file can define a sequence of functions to execute on an image of a document to handle a different type of document, different use case, or different type of document field.

The computing system can receive a request including an image of the document and an identifier or name specifying which function to execute. The computing system can use the identifier received in the request to retrieve a configuration defining a sequence of functions, and then execute the sequence of functions to process the image of the document and identify information, values, numbers, characters, sentences, or fields in the document. Because the functions may be predefined or may be reusable, e.g., the configurations can sequence the same or different functions in a variety of different orders, when new use cases or processing sequences are needed, a user may provide a new configuration with a new sequence of functions or new functions if needed, without requiring a larger redesign of the instructions to process the documents. The system can sequence different machine learning models for various use cases without spending a significant amount of time coding or redesigning a new solution, as the system can be adapted with a new configuration file instead of requiring a partial or complete system redesign.

The functions defined in the configuration file can each be serverless functions. Each function may, when not being executed, not be allocated or consume any (or a small or minimal amount of) computing resources. However, as the computing system executes the sequence of functions, the computing system can cause computing resources to be allocated to each function as the functions are executed. This can result in an efficient use of computing resources, and consume less computing resources (e.g., memory resources, processor resources, power) as compared to conventional systems.

Furthermore, the computing system can include a dynamic digital display that can handle displaying documents or document fields to a user for review or adjudication. The digital display can include a single framework or graphical design that can handle any type of document or field. The single framework can be designed to be generic and display portions of documents along side a predicted identification of the field. Furthermore, in order to efficiently stream information to a front-end system that displays the digital display, the computing system can generate a feed of events that indicate fields of documents that were not properly translated or identified. The feed of events can be pushed to the front-end system through a webhook in order to efficiently and rapidly keep the digital display up-to-date and reduce the amount of requests and messages communicated between the front-end system and the computing system.

The system can blend or combine a high probability of speed and accuracy for unstructured data to be passed as structured data to a consuming system with a combination of artificial intelligence or machine learning model usage as well as an interface for correction by data analysts. Furthermore, the models can be retrained based on input received via the interface, and as the computing system executes, the accuracy of the models can increase, and the end to end process of structuring unstructured document data can increase.

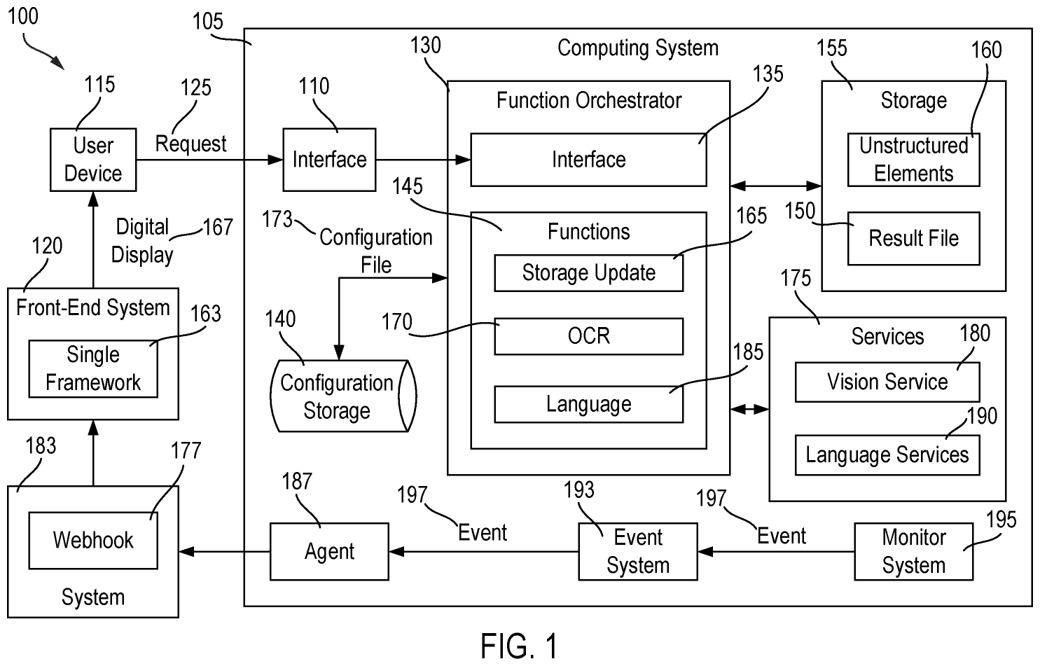

Referring now to FIG. 1, among others, an example system 100 for function sequencing to process unstructured information is shown. The system 100 can be an end to end workflow system or a platform workflow system that can receive unstructured or unlabeled data, such as images, structure the data with artificial intelligence or machine learning techniques, and allow user or expert interaction and intervention in the interpretation of the data. The system 100 can be a configurable platform, and adapt to various use cases, models, or new document or file types. The system 100 can apply rules to structure data and/or export a result file with the structured data to a consuming system, application, or component. The system 100 can include at least one computing system 105. The computing system 105 can be a cloud platform, computing platform, cloud system, distributed computing system, server system, etc.

The computing system 105 can include an interface 110. The interface 110 can be an interface with a user device 115. The interface 110 can be an application programming interface (API) that facilitates communication between the user device 115 and the computing system 105. The user device 115 can be a laptop computer, a desktop computer, a smartphone, a tablet, or any other computing device with a screen and an input device. The user device 115 can execute an application to display, or a web-browser to access, a digital display 167 generated by a front-end system 120. The digital display 167 can be, for example, a graphical user interface (GUI) or other collection of graphic icons, elements, or display portions that can be displayed on a physical screen or display interface. The user device 115 can make API calls to the interface 110, e.g., an ingestion call to ingest a new document file with the computing system 105 for the computing system 105 to process, a get request to retrieve a file queue, a get request to retrieve a size of a file, a save request to save information to a file, or a get request to retrieve a particular file.

The user device 115 can make a request 125 to the interface 110. The computing system 105 can receive the request 125 to identify or structure information in a file, the request including an identifier. The request 125 can be a request to process a data file to identify information in the data file, e.g., identify or recognize information in fields of a file or a request to structure information in the file that is in an unstructured form. The data file can be a data file including unstructured data. For example, the data file can be a scan or an image including pixel values of a document, such as a bill, a check, an order form, a receipt, an application, etc. The request 125 can include the data file, or can include a reference to the data file, such as a link, storage location, etc. The request 125 can include an identifier or name. The identifier or name can indicate the type of the document, the type of processing to execute on the document, or an identifier of a configuration to use in sequencing functions to process the data file. The data file can include data, such as images, of paper or physical documents, such as explanation of benefits (EOB), coordination of benefits (COB), or paper health care claims. The data files can be images of paper health care claims, health care documents, medical records, billing information, etc.

The interface 110 can communicate with a function orchestrator 130 via an interface 135 of the function orchestrator. The interface 135 can be another API for the function orchestrator 130. The function orchestrator 130 can be a computing system, operating system, a virtual machine, or containerized module. The function orchestrator 130 can be, in some implementations, a LINUX instance with auto scaling, e.g., the function orchestrator 130 can scale up or down to consume more computing resources when the function orchestrator 130 requires additional computing resources or release computing resources when the function orchestrator 130 requires less computing resources or is not executing.

The function orchestrator 130 can be coupled with configuration storage 140. The configuration storage 140 can be a key-value storage, a remote dictionary server (REDIS) database, a structured query language (SQL) database, or any other data storage element or database. The configuration storage 140 can store multiple configurations or configuration files 173 linked with identifiers or names. Each configuration can define a sequence of functions to execute for a specific document or specific type of document. Each configuration can identify the functions with function identifiers and further identify whether functions should be execute done after the other, whether one function should operate on the output of another function, whether multiple functions should be executed in parallel, etc. Each configuration file 173 can be a data structure, such as a JavaScript object notation (JSON) file, an extensible markup language (XML) file, a yet another extensible markup language (YAML) file, etc.

Each configuration file 173 stored by the configuration storage 140 can identify a sequence or workflow of reusable functions. The sequence or workflow can identify individual steps to execute different functions, either concurrently, sequentially, or a mixture of concurrent or sequential execution of different reusable functions. Each configuration file 173 can define a different sequence or workflow of reusable functions. For example, one configuration file 173 of the configuration files 173 of the configuration storage 140 can identify functions of the sequence of functions and an order to execute the functions to process a file. A second configuration file 173 of configuration files 173 stored by the configuration storage 140 can identify functions of the sequence of functions and an order to execute the functions to process the file. The configuration files 173 can provide flexibility, configurability, or modularity for the processing of the computing system 105 so that the computing system 105 can be agnostic to the types of unstructured data that can be input to the computing system 105 and can pass through the computing system 105. The configuration files 173 can allow for extracting structured data from any number of types of unstructured or unlabeled data with little or no additional coding or software development. The configuration files 173 can sequence the execution of various functions or models to implement various different use cases, e.g., use cases to process and implement logic for various different types of medical information or medical documents. The configuration files 173 can sequence rules to execute on structured information generated from the medical documents, e.g., determining whether an amount of a claim for a medical bill matches an amount stored in a database, determining whether an amount of a claim exceeds a threshold, determining whether a medical procedure is covered by a medical benefit based on stored medical benefits for a patient, determining whether a user has a specific condition or allergy indicated in a medical record, etc.

The function orchestrator 130 can select a configuration file 173 from multiple configuration files 173 stored by the configuration storage 140 using the identifier received in the request 125. The function orchestrator 130 can utilize the identifier included in the interface 110 to retrieve a configuration file 173 from a set or group of configuration files 173 stored by the configuration storage 140. With the retrieved or selected configuration file 173, the function orchestrator 130 can execute a sequence of functions 145. The function orchestrator 130 or the computing system 105 can include at least one function 145. The functions 145 can be serverless functions that are dynamically allocated memory or processor resources. The functions 145 can be containerized functions, e.g., DOCKER containers, LINUX containers, KUBERNETES containers, etc. The functions 145 can be stored on storage devices, memory devices, in a database, etc. The file imported into the computing system 105 can include unstructured or unlabeled data, such as image data, which the functions 145 can execute to structure or label via at least one model trained by machine learning. For example, the file can include one or multiple images of a document. The images may include pixel data, but may not include any label or identification of printed, written, or typed information on various lines, spaces, boxes, or fields of the document. The functions 145 can operate to structure the file, and can produce a result file 150 that labels or identifies fields of the document and the information written, typed, or printed in the fields.

The function orchestrator 130 can generate and transmit requests to the functions 145 to cause the functions 145 to execute. For example, the function orchestrator 130 can transmit a first request to a first function 145. Responsive to the first function 145 concluding executing and/or storing results in the storage 155, the function orchestrator 130 can transmit a request to a second function 145 to execute on the results of the first function 145. For example, the first function can execute on the file, e.g., the unstructured elements 160, to identify translations or identifications of various portions or fields of the file. The second function 145 can implement one or more rules to compare the portion of the file to other data. For example, a database can store expected values or information for a particular field of the file. The second function 145 can compare the identified value in the file against the stored value to detect whether there is a mismatch. Responsive to detecting a mismatch, the monitor system 195 and/or the second function 145 can generate an alert. For example, an amount billed to a patient can be compared against an amount paid in a check to verify that the amounts match, and a mismatch between the amounts can be used to raise or generate an alert. A function 145 can implement business rules for various different use cases that can consume structured data from the storage 155 for a particular file. The functions 145 can produce structured data from the unstructured information of the input file, have the structured data human or rule validated, and provide the structured data to a consuming system.

The function orchestrator 130 can execute a sequence of the functions 145 defined in the configuration file 173 to identify information in the file received in the request 125. The function orchestrator 130 can generate a result file 150 based on the execution of the functions 145. The computing system 105 can include storage 155. The storage 155 can be or include blob storage, blob storage containers, object storage, file storage, an SQL database, a key-value database, an RDMS, AZURE blob storage, a datalake, etc. The storage 155 can include unstructured elements 160. The unstructured elements 160 can be a Binary Large Object, or blob, and can store the file or portions of the file received in the request 125. The storage 155 can include a result file 150. The result file 150 can include information identified in the file, such as values, characters, phrases, sentences, words, etc. identified for various fields of the file. The result file 150 can be or include the original file image, in addition to the identified information for the file fields. The result file 150 can be a table or list of labels for various fields of the document, and a corresponding value written, typed, or printed in the field of the document. The function orchestrator 130 can generate or build the result file 150 for a particular file based on information identified by the execution of the functions 145 according to the sequence or workflow identified by a configuration file 173.

The functions 145 can include a storage update function 165. The storage update function 165 can manage data stored in the storage 155. The storage update function 165 can split a file or a set of files into unstructured data elements 160. The storage update function 165 can save an entire document file as one unstructured element 160. The storage update function 165 can split the document file into multiple unstructured elements 160, e.g., one unstructured element 160 for each page of the document file or one unstructured element 160 for each field of a page of the document. The storage update function 165 can save the unstructured elements 160 into the storage 155. The unstructured elements 160 can be blobs of pixel or image data or chunked pixel or image data.

The function orchestrator 130 can execute the storage update function 165 responsive to an indication the configuration file 173 that the storage update function 165 should be run. The configuration can indicate rules, steps, or configurations for the storage update function 165 to run. For example, the configuration can indicate that the storage update function 165 should run to split out each page of the file into a different unstructured element 160, or split out different sections, each including multiple pages, into different unstructured elements 160. The configuration can indicate that certain types of information should be split out of a file, e.g., fields, text, images, figures, etc. Each portion of the file split out, removed, or extracted by the storage update function 165 can be stored as a separate unstructured element 160. Other functions 145 can be executed by the function orchestrator 130 to execute the unstructured elements 160 split out by the storage update function 165.

The functions 145 can include at least one optical character recognition (OCR) function 170. The OCR function 170 can be or include intelligent character recognition (ICR). The OCR function 170 can execute on the unstructured elements 160 stored in the storage 155. The OCR function 170 can retrieve the unstructured elements 160 from the storage 155, execute to recognize characters such as numbers, letters, or symbols in the unstructured element, and save the identified characters to the result file 150. The OCR function 170 can be or include at least one model trained by machine learning, such as a neural network or convolutional neural network, to process image data to identify characters of various fields of the file. In some implementations, the OCR function 170 can call a service 175 to execute.

The services 175 can be services of a cloud computing system. For example, the services 175 can be containerized services that can be called to execute by one of the functions 145. For example, the services 175 can include at least one vision service 180. The vision service 180 can be a service that implements machine learning models, such as a neural network or convolutional neural network, that can execute to recognize a character (e.g., letter, number, symbol), an object, a shape, a line, an edge, a boundary, etc. The OCR function 170 can transmit a request to execute the vision service 180 to the services 175 or the vision service 180 to cause the vision service 180 to execute on a specified unstructured element 160. The machine learning models of the services 175 or of the functions 130 can be models trained on health care or medical related data. For example, to process EOB or COB documents, a model can be trained on labeled EOB or COB data, where various EOB or COB fields of a document are labeled or structured for training. The models can be trained on paper health care claims, health care documents, medical records, billing information, etc. The sequence of functions 145 can be designed to specifically handle and process a different type of use case, different medical document use cases, or different medical document types, e.g., a first configuration file 173 can define a sequence of functions 145 to process EOB/COB documents, a second configuration file 173 defining a sequence of functions 145 to process paper medical records, etc.

The functions 145 can include at least one language function 185. The language function 185 can execute on the unstructured elements 160, or characters of the unstructured elements 160 identified by the OCR function 170, to identify words or phrases. For example, the language function 185 can use the words or phrases to identify spelling or grammatical errors. The language function 185 can identify misspellings or improper grammar to detect that the OCR function 170 did not properly translate a word or phrase. The language function 185 can identify a highest probability spelling of a misspelled word, and save the corrected spelling to the unstructured elements 160 or result file 150. The language function 185 can call a language service 190. The language service 190 can be a containerized function that can execute neural networks, deep learning models, language processing models, long-short term neural networks (LSTMs) or any other model trained by machine learning. The language service 190 can implement natural language processing (NLP) or natural language understanding (NLU).

The functions 145 can include an image preprocessing function. The preprocessing function 145 can implement deskew, noise removal, autorotation, etc. The preprocessing function 145 can implement image conversion, e.g., conversion between portable network graphics (PNG), joint photographic experts group (JPEG), graphics interchange format (GIF), bitmap (BMP), tagged image file format (TIFF), etc. Furthermore, the preprocessing function 145 can implement image splitting, e.g., splitting a multipage document into single pages. The functions 145 can include a postprocessing or data grooming function 145. The data grooming function 145 can implement operations to process full page text, to standardize data structures, or to perform content navigation. The post processing function 145 can implement standardizing a data structure, creating or finding columns, creating blocks of text, outputting a text body, creating lines (e.g., standard, asymmetric, index), navigating words and lines that are indexed, returning position by page index or a whole document, finding a line or word index by position, finding a position by word or line, referencing an image or other object by line, word, or position, remembering (set/get) positions or pins by line, word, or position, finding the word, line, or position based on a character index, finding a word, line, or position based on any other metric word, line, or position. The functions 145 can include a content delivery or export function, which can deliver or route a result file 150 to a target or consuming system, application, user account, database, or other target.

The computing system 105 can include at least one monitor system 195. The function orchestrator 130 can, by executing the functions 145, identify a confidence level of each translation, or identification, of characters, words, phrases. The confidence levels can be determined from, or determined to be, confidences of models executed by the functions 145. For example, the result of execution of the functions 145 according to a configuration can be translations of various portions or fields of the file, which can be stored to the storage 155, e.g., to the result file 150. Furthermore, a confidence determined for each portion or field of the file can be stored in the result file 150 with a link or relationship to the corresponding portion or field of the file.

The monitor system 195 can detect that a confidence of an identification of a field, or a translation of a field is less than a threshold or greater than a threshold. The monitor system 195 can compare confidence levels determined by the functions 145 to at least one threshold. For example, the monitor system 195 can have a single threshold, or a different type of threshold for each type of field. Responsive to a detection that the confidence of a particular field is less than a threshold, the monitor system 195 can generate at least one event 197. The computing system 105 can determine that the confidence is greater than a threshold, and pass through the labeling or identification of the information in the file to the result file 150 without requiring or requesting a user to adjudicate or review the determination made by the functions 145. For example, the unstructured data can be extracted through models executed by the functions 145 into structured data, and if the identifications made by the model have a confidence level greater than a threshold, directly passed through to another consuming system without human intervention. The confidence threshold can be set by the configuration file 173. The configuration files 173 of the configuration storage 140 can store a variety of different confidence thresholds for passing through an identification of the information in the file or detecting an error.

The monitor system 195 can generate multiple events 197 that indicate translation or identification errors of various different portions or fields of the file. Each event 197 can indicate a translation or identification error of a different portion or field of the file. The monitor system 195 can generate at least one of the events 197 to include an indication of the field, e.g., an identifier of the field and/or an indication of the confidence level of the translation or identification of the field. The events 197 can all be added to an event topic, which can be managed by an event system 193.

The computing system 105 can include at least one agent 187. The agent 187 can be subscribed to the topic. The agent 187 can receive the events 197 responsive to the events being posted to the topic by the monitor system 195 or the event system 194, and can provide the events 197 to a system 183 for delivery to a front-end system 120 that delivers a digital display 167 to the user via the user device 115. The agent 187 can execute to collect the events 197 published to the event topic and forward the events 197 to the system 183 to be delivered to a front-end system 120 via at least one webhook 177. The system 183 can be a server, web-system, or other computing apparatus or device.

The webhook 177 can be configured to generate and transmit messages or payloads to the front-end system 120 responsive to the events 197. The messages or payloads can be or include the event 197, or the information of the event 197. The system 183 can receive a webhook call to initiate or configure the webhook 177. The webhook 177 can be configured to send a message to the front-end system 120 responsive to detecting an event 197. The message can include an indication of the translation or identification of a field or portion of the file that the function orchestrator 130 determine with a confidence level less than a threshold. The system 183 can, via the webhook 177, push a message to the front-end system 120 to rapidly respond to translation or identification errors. The system 183 can push the message to the front-end system to cause the front-end system 120 to display a digital display 167 including the translation or identification of the portion of the file specified in the message. Because the webhook 177 waits for the events 197 indicating translation or identification errors, the system 183 can transmit corresponding messages to the front-end system 120 to cause the front-end system 120 to display data responsive to a determination that a confidence of a translation or identification of a portion of the file is less than a threshold. The data displayed by the digital display 167 can indicate or include the translation or identified made by the function orchestrator 130 and a portion of the actual original document that the function orchestrator 130 attempted but did not successfully translate or identify.

The front-end system 120 can generate a digital display 167 and cause the user device 115 to display the digital display 167. The front-end system 120 can generate data that causes the digital display 167 to be displayed on a display device of the user device 115. The front-end system 120 can receive messages pushed from the system 183 via the webhook 177. The messages or payloads received from the system 183 can be used by the front-end system 120 to generate the digital display 167. The digital display 167 can allow for a user to review structured data determined by the functions 145 side by side with images of a document to validate the structured data or make corrections to the structured data. A user, such as an analyst, can submit a validated or newly adjusted structured data to the computing system 105 or a final consuming application or system via the digital display 167, an API call, and/or an export.

The digital display 167 can be generated based on a single framework 163. The front-end system 120 can generate data to cause the digital display 167 to display the translations or identifications of the different portions of the file within a single framework, without using different types for frameworks, for different types of files or portions of files. The single framework 163 can define a layout of digital display elements, icons, buttons, graphics, text, fields, etc. The single framework 163 can be agnostic, or may not be specific, to any type of document, document field, document graphic, etc. In this regard, the front-end system 120 can generate a digital display 167 to allow a user to review translation or identification errors in any type of file. This can enable the front-end system 120 to store, load, and process a single framework 163 for all files, instead of storing, loading, and processing multiple different frameworks for various different files, thereby realizing a reduction in processing resources, memory resources, and power consumption resources.

The front-end system 120 can receive various messages from the computing system 105. The messages can be pushed to the front-end system 120 via the system 183 via the webhook 177. The messages can each relate or identify a different translation or identification of a different portion or field of the file. For example, a first message can indicate that there was an error identifying information in a first field, while a second message can indicate that there was an error identifying information in a second field. The messages may only include indications that there were errors in various fields, but may not include the field itself or an identification or translation of the field. The messages can include identifiers or links to the fields themselves stored in the storage 155, or identifiers or links to the identifications or translations of the fields stored in the storage 155. In this regard, the front-end system 120 can retrieve the fields or identifications of the fields from the storage 155 by using or resolving the links or identifiers of the messages.

For example, the front-end system 120 can generate the digital display 167 to display a digital display element, such as a list. The list can identify different files that the computing system 105 is processing, will process, or has processed. The front-end system 120 can generate the list of files based on the messages received via the webhook 177. The messages can each identify a particular file that the message was generated for, and the front-end system 120 can use the messages to identify the list of files. Furthermore, the list can include indications of translation or identification errors for the files. For example, for a specific file, the front-end system 120 can generate the digital display 167 to list out or specify the various translation or identification errors for the file.

A user, via the digital display 167 and the user device 115, can provide an input selecting a particular file or error of a particular file. Responsive to receiving a selection of a file or error, the front-end system 120 can transmit at least one request to the computing system 105. The request can be a query or API call that requests errors of a specified file or a specific error. The request can be for data or a data structure, for example, the unstructured elements 160. The data structure requested by the front-end system 10 can represent data of or a representation of a field of a file. The data structure can be an image or a portion of an image of the file including the field. The data structure can be marked with an error flag or identifier, that indicates that the function orchestrator 130 could not identify the information of the field with a confidence greater than a threshold (e.g., the function orchestrator 130 identified the information of the field with a confidence less than the threshold). The computing system 105 can respond to the front-end system 120 the requested information, and the front-end system 120 can generate data to cause the digital display 167 to display the returned information. For example, the front-end system 120 can generate the digital display 167 to include an indication of the requested file, the file itself, or the portion of the file with the error (e.g., the specific field in the file with the error), and the identification, translation, or structured information that the function orchestrator 130 attempted to generate for the field.

The front-end system 120 can generate the digital display 167 with the single framework to display the returned information. The single framework 163 can define a first element to display the field or portion of the file that the function orchestrator 130 encountered an error in identifying. The single framework 163 can define a second element to display an attempted identification of the field or portion of the file, or a list of attempted identifications. The list of attempted identifications can be ranked in order of decreasing confidence levels. A user can adjudicate, via the list, the identification of the field or the portion of the file by selecting one of the identifications in the list to be used for the field. The single framework 163 can define a third element to allow a user to input, type, or provide an identification of the field. For example, a user can type in a number, phrase, or set of characters that appear in the portion or field of the file. Responsive to receiving a user entered identification of the portion or field of the file, the front-end system 120 can transmit a request, command, or message to the computing system 105 to cause the computing system 105 to store the user input in the storage 155 (e.g., in the unstructured elements 160 or the result file 150).

In some implementations, the computing system 105 can digitize the EOB images (e.g., a statement summarizing costs or claims for health care services) that include one or multiple pages. The images can include data of a medical claim. The computing system 105 can validate the digitized or extracted data, and then rate the confidence of the extracted data. If the confidence assessment is above a configurable threshold, the computing system 105 can submit the claim automatically for adjudication. If the rating falls below the configurable threshold, the computing system 105 can place the claim in a queue accessible via the digital display 167, allowing a specialist to manually review the claim and its associated extracted values. When the specialist selects a claim from their queue via the digital display 167, the image of the claim can be displayed in the digital display 167. The digital display 167 can dynamically display the extracted data and labels for all of the extracted data. Low confidence values of extracted data can be highlighted in the digital display 167 so the specialist can hone their effort specifically to those values, make any adjustments to the extracted data via the digital display 167, and then resubmit a claim via the digital display 167 through the process of validation and confidence evaluation until the claim passes to adjudication. Not only can claims cycle through these steps, possibly with no manual intervention from a specialist, but if there is intervention needed, it can be greatly reduced because it is targeted to the specific small subset of low confidence values.

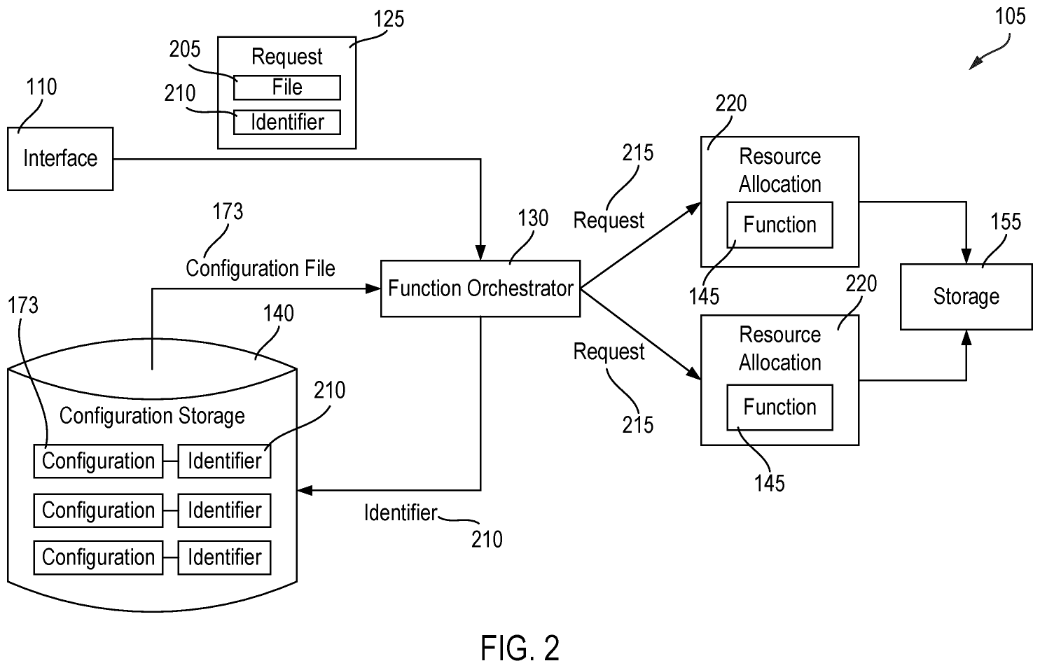

Referring now to FIG. 2, among others, an example computing system 105 for dynamically allocating resources to functions 145 to process unstructured information is shown. The interface 110 can receive the request 125 from the user device 115 including a file 205 and an identifier 210. The file 205 can be a picture, scan, or data structure representing a document, such as a digital document or a physical paper document. The file 205 can be a portable document format (PDF) file, a TIFF file, a GIF file, a JPEG file, a BMP file, or a PNG file. The identifier 210 can be a number, code, name, document type identifier, document type name, processing use case identifier, etc. The file 205 can be an image including pixels or pixel data of information in the document. The pixels or pixel data, or the entire image itself, can be unlabeled. For example, pixels of various fields of the document may be unlabeled, e.g., the image may not specify the type or name of the field or the information, letters, phrases, values, o numbers entered into the field.

The function orchestrator 130 can extract or retrieve the identifier 210 from the request 125. Responsive to receiving the request 125, or extracting the identifier 210, the function orchestrator 130 can retrieve a configuration file 173 from the configurations storage 140. For example, the function orchestrator 130 can query the configuration storage 140 with the identifier 210 retrieve a corresponding configuration file 173. The configuration storage 140 can store multiple configuration files 173, each linked to a different identifier 210. The configuration storage 140 can resolve the query to identify the configuration file 173 linked to the identifier 210 of the query. The configuration storage 140 can provide the corresponding configuration file 173 to the function orchestrator 130 in a response message.

The function orchestrator 130 can cause the functions 145 to be allocated with resources and to execute in a particular order according to data of the configuration file 173. The function orchestrator 130 can identify an order to execute various different functions 145, e.g., execute a function 145, then execute a second function 145, then execute a third function 145, etc. For example, the sequence of functions defined by the configuration file 173 includes a first function 145 to execute on the file 205 followed by a second function 145 to execute on the file 205.

The function orchestrator 130 can allocate processing resources to different functions 145. The processing resource allocation 220 can be processor or memory resources. For example, the processing resource allocation 220 can be an allocation of a particular number of servers, processor cores, processing devices, etc. The processing resource allocation 220 can be an allocation of a partition of memory, a set of memory addresses, a number of memory devices, a number of gigabytes, megabytes, or kilobytes allocated, etc. The processing resource allocation 220 can be power allocation resources (e.g., a total amount of power that the function 145 can consume when executing). For example, the function orchestrator 130 can generate requests 215 to cause the functions 145 to run or to have resources to be allocated for executing functions 145. The requests 215 can be indications to initiate processing of a specified function 145. In some implementations, the function orchestrator 130 transmits a request 215 to a particular function to request that the function run, execute, or be allocated resources. The requests 215 can be events, in some implementations. For example, the function orchestrator 130 can transmit a first request 215 to a first fucntion1 45 to cause the first function to execute on the file 205.

For example, responsive to the first function 145 executing on the file 205, the function orchestrator 130 can transmit the second request 215 to a second function 145 to cause the second function 145 to execute. For example, responsive to the first function 145 concluding execution or generating an output, the function orchestrator 130 can transmit a second request 215 to a second function 145 to cause the second function to execute on the file 2015 (or on the output of the first function 145).

The function orchestrator 130 can cause each function 145 to receive a resource allocation 220. The function orchestrator 130 may only assign the resource allocation 220 to the function 145 when the function 145 needs to execute, e.g., responsive to the request 215. In this regard, less resources can be consumed when processing a particular file 205, and the file 205 can be processed significantly faster (e.g., in seconds as compared to minutes). Instead of allocating the resources to all the operations needed to process a file 205, during the sequence of execution of different functions, each function can receive a resource allocation 220 when that function needs to execute. In this regard, the same resources can be used by different functions 145. For example, a first function and a second function that execute consecutively can utilize the same resources. The first function 145 can receive the resource allocation 220, execute with the resource allocation 220, and then release the resource allocation 220. For example, responsive to the first function 145 completing processing the file 205, the first memory or processing resources of the resource allocation can be released, and freed to be allocated to a different function 145 or other computing executable. The second function 145 can receive the same resource allocation 220 after the first function 145 finishes executing, execute with that resource allocation 220, and then release the resource allocation 220 responsive to the second function 145 ending execution. The second function 145 can receive the resource allocation 220 after the first function 145 completes or ends processing the file 205.

Because each of the functions 145 can execute models, such as deep neural networks that can require a significant amount of processing or memory resources to execute, by allocating the resources as the functions 145 execute in a series, sequence, or workflow, less resources may be needed to process the file 205 compared to all the functions 145 being loaded into memory together, and thereby consuming memory resources before the functions 145 need to execute.

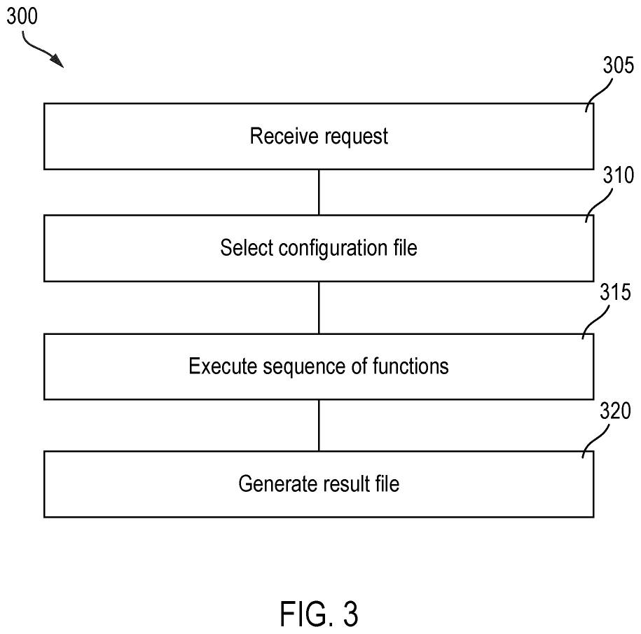

Referring now to FIG. 3, among others, a method 300 of function sequencing to process unstructured information is shown. At least a portion of the method 300 can be executed by the user device 115, the computing system 105, the system 183, or the front-end system 120. The method 300 can include an ACT 305 of receiving a request. The method 300 can include an ACT 310 of selecting a configuration file. The method 300 can include an ACT 315 of executing a sequence of functions. The method 300 can include an ACT 320 of generating a file.

At ACT 305, the method 300 can include receiving, by the computing system 105, a request 125. The computing system 105 can receive a request 125 including a file 205 and/or the identifier 210. The computing system 105 can receive the request 125 from a user device 115 responsive to a user uploading a file to the computing system 105. The computing system 105 can receive the request 125 via at least one network, such as the Internet. The computing system 105 can receive a batch or set of requests 125 for a set of files 205 to be processed by the computing system 105, and have information in the files 205 identified and structured in a result file 150. In some implementations, the file 205 provide in the request 125 can be unstructured information, e.g., images of text, words, phrases, sentences, numbers, etc. The result file 150 can identify the information of the file 205 in a structured manner. For example, the file 205 can store pictures or images of a field, while the result file 150 can include identified characters stored in strings.

At ACT 310, the method 300 can include selecting, by the computing system 105, a configuration file 173. The computing system 105 can use the identifier 210 to retrieve the configuration file 173 from the configuration storage 140. The computing system 105 can query the configuration storage 140 with the identifier 210 to select, identify, or retrieve a configuration file 173 linked, related, or associated with the identifier 210. The computing system 105 can store a set, group, or multiple configuration files 173, each linked, related or associate with a different identifier 210.

At ACT 315, the method 300 can include executing, by the computing system 105, a sequence of functions. For example, the configuration file 173 selected at ACT 310 can identify different functions and the order in which the functions should execute. The configuration file 173 can identify different functions with a name or identifier of each function. The configuration file 173 can include data that indicates the sequence of functions to be executed, whether functions are executed one after another, whether one function executes on the output of another function, whether multiple functions should be executed in parallel, etc. The function orchestrator 130 can process the configuration file 173 to sequence the execution of the functions 145 according to the function sequence defined in the configuration file 173. The function orchestrator 130 can transmit requests 215 to cause the functions 145 to receive a resource allocation 220 and execute with the resource allocation 220 according to the sequence of functions defined by the configuration file 173.

At ACT 320, the method 300 can include generating, by the computing system 105, the result file 150. As the functions 145 execute, the functions 145 can store information, such as identifications of the fields of the file 205 in the result file 150. The resulting result file 150 can include strings, values, or text in a structured format, e.g., in strings, with doubles, as integers, instead of pixel or image data of the various fields received in the file 205. The result file 150 can be delivered, transmitted, or sent to the user device 115. For example, the result file 150 can be displayed in the digital display 167. In some implementations, the computing system 105 can transmit identification errors for various fields of the file 205 as events 197 to a system 183, which can transmit the errors to a front-end system 120 via a webhook 177. The front-end system 120 can cause, via a single framework 163, an indication of the identification of the field and the field itself to allow a user to review and adjudicate the errors.

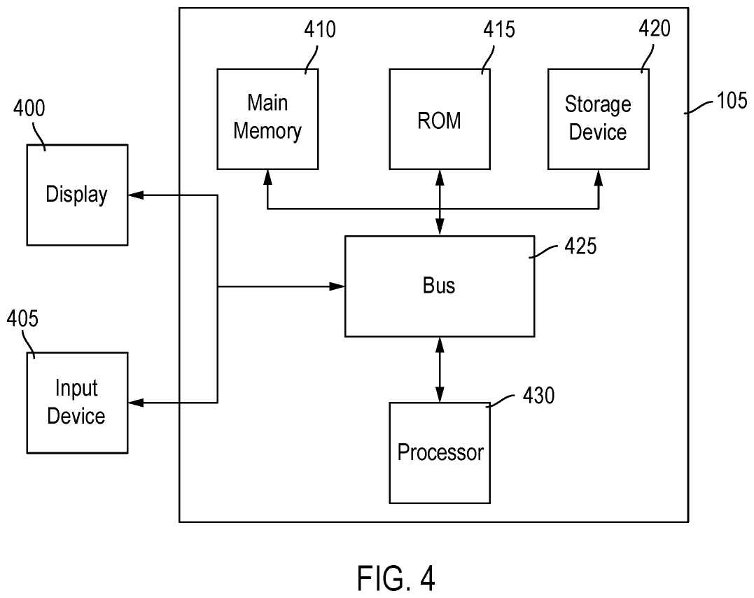

Referring now to FIG. 4, among others, an example block diagram of the computing system 105 is shown. The computing system 105 can include or be used to implement a data processing system or its components. The architecture described in FIG. 4 can be used to implement the computing system 105, or any other computing device. The computing system 105 can include at least one bus 425 or other communication component for communicating information and at least one processor 430 or processing circuit coupled to the bus 425 for processing information. The computing system 105 can include one or more processors 430 or processing circuits coupled to the bus 425 for processing information. The computing system 105 can include at least one main memory 410, such as a random access memory (RAM) or other dynamic storage device, coupled to the bus 425 for storing information, and instructions to be executed by the processor 430. The main memory 410 can be used for storing information during execution of instructions by the processor 430. The computing system 105 can further include at least one read only memory (ROM) 415 or other static storage device coupled to the bus 425 for storing static information and instructions for the processor 430. A storage device 420, such as a solid state device, magnetic disk or optical disk, can be coupled to the bus 425 to persistently store information and instructions.

The computing system 105 can be coupled via the bus 425 to a display 400, such as a liquid crystal display, or active matrix display. The display 400 can display information to a user. An input device 405, such as a keyboard or voice interface can be coupled to the bus 425 for communicating information and commands to the processor 430. The input device 405 can include a touch screen of the display 400. The input device 405 can include a cursor control, such as a mouse, a trackball, or cursor direction keys, for communicating direction information and command selections to the processor 430 and for controlling cursor movement on the display 400.

The processes, systems and methods described herein can be implemented by the computing system 105 in response to the processor 430 executing an arrangement of instructions contained in main memory 410. Such instructions can be read into main memory 410 from another computer-readable medium, such as the storage device 420. Execution of the arrangement of instructions contained in main memory 410 causes the computing system 105 to perform the illustrative processes described herein. One or more processors in a multi-processing arrangement can be employed to execute the instructions contained in main memory 410. Hard-wired circuitry can be used in place of or in combination with software instructions together with the systems and methods described herein. Systems and methods described herein are not limited to any specific combination of hardware circuitry and software.

Although an example computing system has been described in FIG. 4, the subject matter including the operations described in this specification can be implemented in other types of digital electronic circuitry, or in computer software, firmware, or hardware, including the structures disclosed in this specification and their structural equivalents, or in combinations of one or more of them.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer readable storage medium, and modules can be distributed across various hardware or computer based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C#, PROLOG, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or example, and references to “an implementation,” “some implementations,” “one implementation” or the like are not necessarily mutually exclusive and are intended to indicate that a particular feature, structure, or characteristic described in connection with the implementation may be included in at least one implementation or example. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

What is claimed is:

1. A system, comprising:
one or more memory devices storing instructions thereon, that, when executed by one or more processors, cause the one or more processors to:
receive a request to identify information of a document stored in a file, the request comprising an identifier;
select a configuration file from a plurality of configuration files using the identifier;
execute a sequence of functions defined by the configuration file to identify the information in the file; and
generate a result file including the information identified by execution of the sequence of functions.

2. The system of claim 1, wherein:
the file includes at least one image of the document; and
the information of the document is represented as unlabeled pixel data in the image.

3. The system of claim 1, wherein:
the configuration file identifies functions of the sequence of functions and an order to execute the functions to process the file of the document; and
a second configuration file of plurality of configuration files identifies functions of the sequence of functions and an order to execute the functions to process the file.

4. The system of claim 1, wherein functions of the sequence of functions are serverless functions;
wherein the instructions cause the one or more processors to:
allocate first memory or processing resources to a first function of the sequence of functions;
execute the first function to process the file of the document with the first memory or processing resources;
release the first memory or processing resources responsive to the first function completing processing the file;
allocate second memory or processing resources to a second function of the sequence of functions responsive to a completion of the first function; and
execute the second function to process the file with the second memory or processing resources.

5. The system of claim 1, wherein:
the sequence of functions defined by the configuration file includes a first function to execute on the file followed by a second function to execute on the file; and
the instructions cause the one or more processors to:
store a plurality of functions on the one or more memory devices;
transmit a request to the first function to execute on the file; and
transmit a request to the second function to execute on the file responsive to the first function executing on the file.

6. The system of claim 1, wherein:
the instructions cause the one or more processors to:
execute a function of the sequence of functions defined by the configuration file to split the document into a plurality of portions;
store a plurality of unstructured data elements for the plurality of portions of the document; and
execute at least one function of the sequence of functions defined by the configuration file on the plurality of unstructured data elements.

7. The system of claim 1, wherein the instructions cause the one or more processors to:
generate an identification of a portion of the document;
determine that a confidence of the identification is less than a threshold;
generate a message to include an indication of the identification and the portion of the document; and
push the message to a front-end server to cause the front-end server to display the identification and the portion of the document on a digital display.

8. The system of claim 1, wherein the instructions cause the one or more processors to:
transmit, using a webhook, a message to a front-end server to cause the front-end server to display data responsive to a determination that a confidence of an identification of a portion of the document is less than a threshold,
the data comprising an indication of the identification of the portion of the document and an indication of the portion of the document.

9. The system of claim 1, wherein the instructions cause the one or more processors to:
receive a plurality of messages comprising identifications of different portions of the document; and
generate data to cause a digital display to display the identifications of the different portions of the document within a single framework, without using different types for frameworks, for different types of documents or portions of documents.

10. The system of claim 1, wherein:
the sequence of functions defined by the configuration file includes a first function to execute on the file followed by a second function to execute on the file;
the instructions cause the one or more processors to:
transmit a request to the first function to execute on the file to identify an identification of a portion of the document;
transmit a request to the second function to compare the identification of the portion of the document with data of a database to generate an alert; and
generate data to cause a digital display to display the alert.

11. The system of claim 1, wherein the instructions cause the one or more processors to:
generate data to cause a digital display to display a list of a plurality of documents comprising identification errors, the plurality of documents comprising the document;
receive a selection of the document from the plurality of documents;
transmit a request to a back-end server to request a data structure from storage, the data structure representing a field of the document with an error flag; and
generate data to cause the digital display to display an indication of the field of the document using the data structure.

12. The system of claim 1, wherein the instructions cause the one or more processors to:
generate data to cause a digital display to display an indication of a field of the document with an identification error;
receive user input via the digital display comprising an identification of the field; and
transmit an update to the field to a back-end server responsive to receiving the identification of the field to cause the back-end server to store the identification received via the digital display.

13. The system of claim 1, wherein the instructions cause the one or more processors to:
generate a plurality of events that indicate identification errors of a plurality of different portions of the document;
publish the plurality of events to an event topic, wherein an agent is subscribed to the event topic; and
execute the agent to collect the plurality of events published to the event topic and forward to events to a server to be delivered to a front-end server via at least one webhook.

14. A method, comprising:
receiving, by one or more processing circuits, a request to identify information of a document stored in a file, the request comprising an identifier;
selecting, by the one or more processing circuits, a configuration file from a plurality of configuration files using the identifier;
executing, by the one or more processing circuits, a sequence of functions defined by the configuration file to identify the information in the file; and
generating, by the one or more processing circuits, a result file including the information identified by execution of the sequence of functions.

15. The method of claim 14, wherein:
the configuration file identifies functions of the sequence of functions and an order to execute the functions to process the file; and
a second configuration file of plurality of configuration files identifies functions of the sequence of functions and an order to execute the functions to process the file.

16. The method of claim 14, comprising:
executing, by the one or more processing circuits, a function of the sequence of functions defined by the configuration file to split the document into a plurality of portions;
storing, by the one or more processing circuits, a plurality of unstructured data elements for the plurality of portions of the document; and
executing, by the one or more processing circuits, at least one function of the sequence of functions defined by the configuration file on the plurality of unstructured data elements.

17. The method of claim 14, comprising:
generating, by the one or more processing circuits, an identification of a portion of the document;
determining, by the one or more processing circuits, that a confidence of the identification is less than a threshold;
generating, by the one or more processing circuits, a message to include an indication of the identification and the portion of the document; and
pushing, by the one or more processing circuits, the message to a front-end server to cause the front-end server to display the identification and the portion of the document on a digital display.

18. The method of claim 14, comprising:
receiving, by the one or more processing circuits, a plurality of messages comprising identifications of different portions of the document; and
generating, by the one or more processing circuits, data to cause a digital display to display the identifications of the different portions of the document within a single framework, without using different types for frameworks, for different types of documents or portions of documents.

19. One or more storage media storing instructions thereon that, when executed by one or more processors, cause the one or more processors to perform operations comprising:
receiving a request to identify information of a document stored in a file, the request comprising an identifier;
selecting a configuration file from a plurality of configuration files using the identifier;
executing a sequence of functions defined by the configuration file to identify the information in the file; and
generating a result file including the information identified by execution of the sequence of functions.

20. The one or more storage media of claim 19, wherein the operations further comprise:
receiving a plurality of messages comprising identifications of different portions of the document; and
generating data to cause a digital display to display the identifications of the different portions of the document within a single framework, without using different types for frameworks, for different types of documents or portions of documents.
